(19) United States
(12) Patent Application Publication
(10) Pub. No.: US 2024/0420203 A1
(43) Pub. Date: Dec. 19, 2024

(54) Accessing Information Associated With Digital Components

(71) Applicant: Google LLC, Mountain View, CA (US)

(72) Inventors: Yash Parikh, San Carlos, CA (US); Kwaku Obeng Akoi, Richardson, TX (US); Jae Min Kim, San Ramon, CA (US); Neil Mitan Gandhi, Dublin, CA (US)

(21) Appl. No.: 18/209,828

(22) Filed: Jun. 14, 2023

(51) Int. Cl. G06Q 30/0601; G06K 7/14

(52) U.S. Cl. CPC G06Q 30/0623; G06K 7/1417

(57) ABSTRACT

The technology is generally directed to providing information associated with a digital component via a visual code after confirming the user scanning the visual code is authorized to access the information. The visual code may be provided for output within or near a digital component on a display device. When the visual code is scanned by an image capturing device, account data associated with the digital component may be compared to profile data of a user profile that is logged into the image capturing device. When the account data corresponds to the profile data, the data associated with the digital component may be provided for display on the image capturing device. When the account data does not correspond to the profile information, a prompt may be provided.

### BACKGROUND

Users within the viewing range of content, such as streaming content, typically can view all advertisements that are output along with the content. Users, therefore, can typically view all data provided with the advertisements. The user streaming the content may not want others within viewing range of the content to view the data. The user streaming the content, therefore, will have to quickly close the window or fast forward through the data to prevent others from viewing the data. However, closing the window or fast forwarding limits the ability for the user streaming the content to view the data.

### BRIEF SUMMARY

The technology is generally directed to providing information, or data, associated with a digital component via a visual code after confirming the user scanning the visual code is authorized to access the information. The visual code may be provided for output within or near a digital component on a display device, such as a television, computer monitor, or the like. The visual code may be generated based on a uniform resource location (URL). The URL may be generated based on signals extracted from account information, the digital component, etc. The account information may be information and/or data associated with the user account of the content provider. When the visual code is scanned by an image capturing device, the account information associated with the digital component may be compared to profile information of a user profile that is logged into a user device including the image capturing device. When the account information corresponds to the profile information, the information associated with the visual code and, therefore, the digital component may be provided for display on the user device. When the account information does not correspond to the profile information, a prompt may be provided for display on the user device prompting the user to sign into a user profile having profile information that corresponds to the account information.

A first aspect of the technology includes a method, comprising receiving, by one or more processors from a first device, a request for data associated with a visual code, the visual code being associated with a digital component and account data, wherein the request comprises profile data associated with a second device, comparing, by the one or more processors, the account data and the profile data to determine whether the account data corresponds to the profile data, and providing for display on the second device, by the one or more processors, the data associated with the visual code after determining the account data corresponds to the profile data.

The method may further comprise providing for display on the second device, by one or more processors, the visual code and the digital component. The account data may be associated with a user account. The user account may be associated with a content provider providing the digital component for display on the second device.

The data associated with the visual code is at least one of privacy data, advertiser disclosures, or digital component personalization data. According to some examples, the data may be associated with the digital component. The digital component personalization data may include an option to increase, decrease, or block a subject of the digital component. The subject of the digital component may correspond to a category or classification of at least one of products, goods, or services.

The account data and the profile data may each include an email address. When comparing the account data and the profile data the method may further comprise comparing the email address associated with the account data and the email address associated with the profile data.

When the account data does not correspond to the profile data, the method may further comprise providing for display on the first device, by the one or more processors, a prompt to log-in or switch to a user profile having profile data corresponding to the account data.

The visual code may be a QR code. In some examples, the visual code may be a bar code, a visual indication, or the like.

A second aspect of the disclosure is directed to a system comprising one or more processors. The one or more processors may be configured to receive, from a first device, a request for data associated with a visual code, the visual code being associated with a digital component and account data, wherein the request comprises profile data associated with a second device, compare the account data and the profile data to determine whether the account data corresponds to the profile data, and provide for display on the second device the data associated with the visual code after determining the account data corresponds to the profile information.

A third aspect of the disclosure is directed to a computer-readable storage medium, the computer-readable storage medium including instructions that when executed by one or more processors, cause the one or more processors to: receive, from a first device, a request for data associated with a visual code, the visual code being associated with a digital component and account data, wherein the request comprises profile data associated with a second device, compare the account data and the profile data to determine whether the account data corresponds to the profile data, and provide for display on the second device the data associated with the visual code after determining the account data corresponds to the profile data. The computer-readable storage medium may be a non-transitory computer readable storage medium. The computer-readable medium may further include instructions that when executed by one or more processors, cause the one or more processors to carry out the method of the first aspect.

### BRIEF DESCRIPTION OF THE DRAWINGS

FIG. 1 is a screenshot illustrating example content, including a visual code associated with a digital component in accordance with aspects of the disclosure.

FIG. 2A is another screenshot illustrating example content in accordance with aspects of the disclosure.

FIG. 2B is a screenshot illustrating example content provided in response to an input associated with a digital component in accordance with aspects of the disclosure.

FIG. 3 is a flow diagram for an example method of generating a visual code in accordance with aspects of the disclosure.

FIG. 4 is a screenshot illustrating example content provided after scanning a visual code in accordance with aspects of the disclosure.

FIG. 5 is a screenshot illustrating alternative example content provided after scanning a visual code in accordance with aspects of the disclosure.

FIG. 6 is a block diagram of an example system in accordance with aspects of the disclosure.

FIG. 7 is a flow diagram for an example method of providing information associated with a digital component in accordance with aspects of the disclosure.

### DETAILED DESCRIPTION

The technology is generally directed to providing information associated with a digital component via a visual code after confirming the user device scanning the visual code is authorized to access the information. The visual code may be output on a display of a television, computer monitor, or the like, within or near a digital component. When the visual code is scanned by the image capturing device, the account information associated with the digital component may be compared to profile information of a user profile that a user is logged into on a user device including the image capturing device. When the account information corresponds to the profile information, the information associated with the visual code may be provided for display on the user device. In examples where the account information does not correspond to the profile information, a prompt may be provided on the user device to switch user profiles, sign into a user profile having profile information corresponding to the account information, or the like.

The visual code may be associated with the digital component and account information corresponding to a user account. The visual code may be generated at the time the digital component is generated such that the visual code is output within the digital component at the time the digital component is provided for output. In some examples, a selectable input may be provided within or near the digital component at the time the digital component is provided for output. In such an example, after the device displaying the digital component receives an input corresponding to the selection of the selectable input, the visual code may be provided for display.

The visual code may be generated based on signals extracted from the user account associated with the content provider. The user account may be, in some examples, associated with a content provider, such as an online content subscription service, a connected television (CTV) device, or the like. The content provider may provide the digital component for output. In some examples, the content provider may be different from the digital component provider. The user account may be associated with login information, such as a username and password, and user information, such as name, address, location, email address, phone number, etc. In some examples, the email address may be the username for the user account.

According to some examples, the visual code may be generated based on parameters associated with the digital component. The parameters may include, for example, contextual signals, digital component targeting, location information, interest information, etc. Contextual signals may be, for example, signals determined based on the content that the user being presented the digital component previously viewed and/or is currently viewing. Digital component targeting may be, for example, a target audience identified by the digital component provider. The target audience may be a group or type of users the digital component provider seeks to present the digital component to. The location information may be, for example, regional, local, state, etc., information. Interest information may be interest profiles of the users generated based on contextual signals, user provided information, or the like.

In some examples, the visual code may be generated based on a uniform resource location. The URL may be generated based on the signals extracted from the user account and/or parameters associated with the digital component. The URL may include a large amount of encrypted data such that the visual code may be densely populated with a plurality modules. For example, the greater the amount of information to be included in the visual code may result in a more densely populated visual code. The denser the visual code is, the more difficult it may be for an image capturing device to accurately capture and discern the visual code. This is particularly the case when the image capturing device is positioned away from the display providing the digital component for output. To address this issue, a shortened URL may be created based on the original URL having a large amount of encrypted data. The visual code may then be generated based on the shortened URL. The visual code generated using the shortened URL may allow for the image capturing device to more easily capture and discern the modules of the visual code from both near, e.g., inches away, and far, e.g., television viewing distance away.

When the visual code is scanned, the shortened URL associated with the visual code may redirect the content page to the original URL, such that the information associated with the original URL may be provided for display on the user device. The information may include, for example, privacy information, disclosures related to the digital component, digital component personalization information, an explanation regarding why the user is seeing the digital component, or the like.

The information associated with the visual code may only be provided after confirming that the account information associated with the user account of the content provider matches the profile information associated with a user profile of the user logged into the imaging device used to scan the visual code. For example, the user profile of the user logged into the imaging device may include login information, such as a username and password, name, address, location, email address, phone number, etc. As one example, the email address associated with the user account of the content provider may be compared to the email address associated with the user profile of the user logged into the imaging device. If the email addresses match, the information associated with the visual code may be provided for display on the imaging device.

In examples where the account information associated with the user account for the content provider does not match the profile information of the user profile of the user logged into on the imaging device, the information associated with the digital component is not provided for display. Rather, a prompt may be provided for display on the imaging device to log-in or switch to a user profile having profile information corresponding to the account information.

By comparing the account information associated with the content provider to the profile information associated with a user profile of a user logged into on the imaging device used to scan the visual code, the number of transactions between the content provider and the user device may decrease. For example, the efficiency of determining whether to provide access to the information associated with the visual code may be increased by comparing the account information and profile information as compared to requesting a user to log in each time the visual code is scanned. By increasing the efficiency of providing access to the information associated with the digital component, less network bandwidth may be used by way of fewer transactions between user device and server in order to grant access. As a result of the comparison between account information and profile information, access speed can also be improved.

According to some examples, creating a visual code for the information associated with the digital component may allow for the amount of information provided to be increased, without changing how the information is accessed. For example, as disclosure requirements associated with digital components change and/or more personalization options are available, the visual code may continue to be generated in the same way, e.g., a large URL is created based on all the signals and information, a shortened URL is created based on the large URL, and a visual code is created based on the shortened URL such that, when scanned, the shortened URL associated with the visual code leads a user to the content page of the large URL. This may reduce the downtime of an application as no updates would be necessary to increase the amount of information or change the information provided via the visual code. Further, this may reduce distribution requirements for multiple users in that network resources would not need to be used in order to update the data that is provided to users because an app update at the user device is not required.

While the term “information” is used throughout with respect to information associated with the digital component, account information, profile information, etc., the term “data” may be used interchangeably with the term “information.”

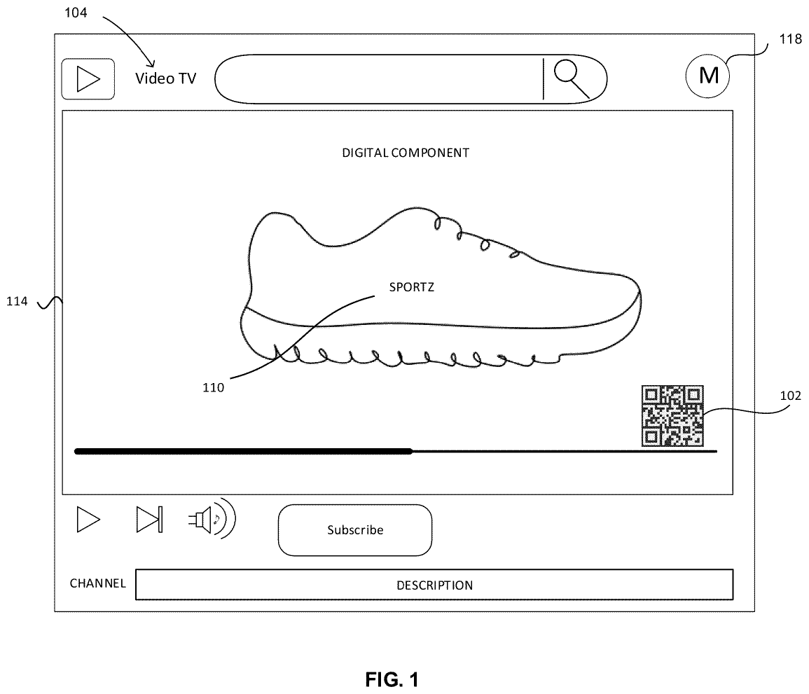

FIG. 1 illustrates example content being output on a display device. The content 114 may include, for example, digital components, videos, images, information, etc. The content 114 may be provided by a content provider 104. The content provider may be, for example, an online content subscription service, a CTV device, or the like. For example, the content provider may provide content 114 for display on the display device.

A user account 118 may be associated with the content provider 104. For example, a user account 118 may be created and used to access the online content subscription service, enable the CTV device, or the like. According to some examples, the user account 118 may include log-in information, such as a username and password, and user information, such as the name, address, location, e-mail address, phone number, etc., associated with the user. In some examples, the user account 118 may include user preferences regarding interests related to types of content, digital components, etc. User account 118 may, in some examples, allow for customization of the types of content to be provided by the content provider 104, the types of digital components to be provided, or the like.

As shown, the content 114 is a digital video component for a retail store selling shoes. According to some examples, digital components may include, for example, advertisements. The content provider 104 may be different than the digital component provider. For example, the digital component provider may be the brand 110, an online retailer, a physical store, etc., whereas the content provider 104 may be the streaming service, CTV device, etc.

The content 114 may include a visual code 102. The visual code 102 may be, for example, a QR code, bar code, or the like that can be scanned by an image capturing device, such as a camera of a user device. As shown, the visual code 102 is provided for output as part of the content 114. However, the visual code 102 may be provided in response to an input.

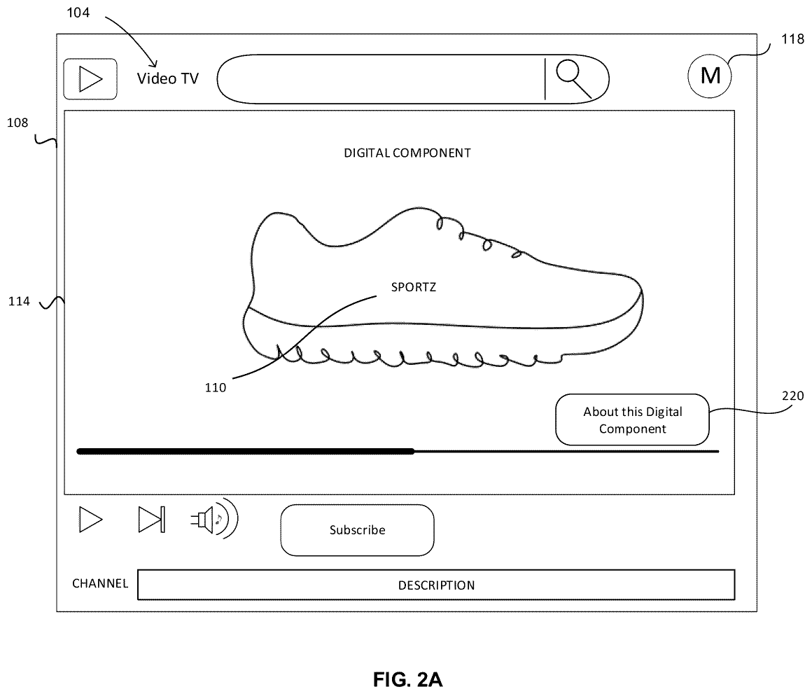

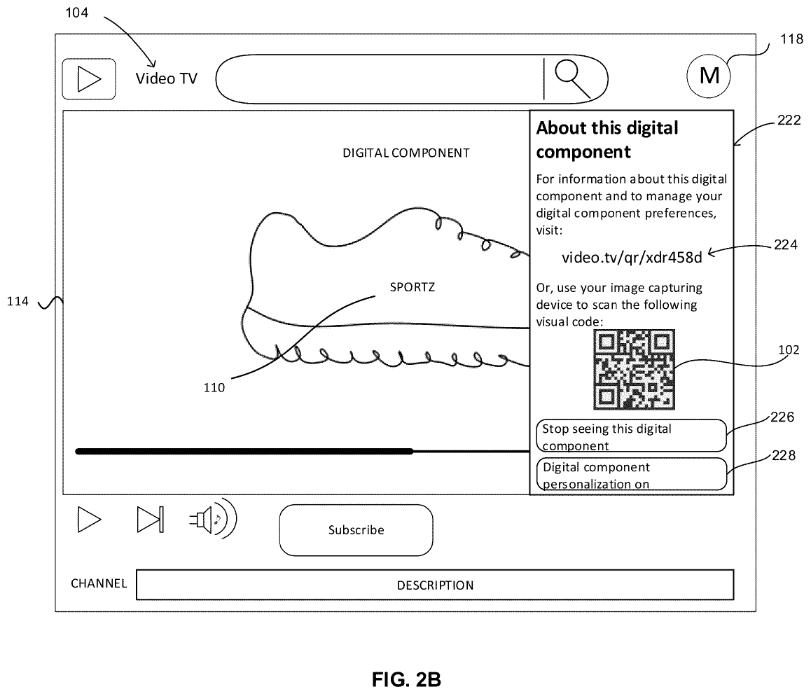

FIG. 2A illustrates example content being output on a display device. Rather than the content 114 including the visual code 102, as shown in FIG. 1, the content 114 includes an input 220. The input 220 may be to learn more about the digital component. According to some examples, the display device 108 may be configured to receive an input corresponding to the selection of input 220.

FIG. 2B illustrates example content being output on a display device in response to a selection of input 220. Only displaying content in response to a selection input saves rendering resources and transmission bandwidth involved with displaying content that is not desired. For example, in response to receiving an input corresponding to the selection of input 220, an overlay 222 may be provided for output. The overlay 222 may include, for example, one or more options to accessing information about the digital component. For example, the overlay 222 may include a URL 224 and/or a visual code 102. The visual code 102, when scanned by an image capturing device, may direct the user device including the image capturing device to the same location as the URL 224.

In some examples, the overlay 222 may include inputs 226, 228. Inputs 226, 228 may correspond to one or more options for personalizing digital components. For example, input 226, when selected, may prevent the digital component, e.g., content 114, from being provided for output by the content provider 104 in the future. In some examples, input 228 may allow for a user to turn digital component personalization on and off. For example, when digital component personalization is turned on, the digital components, e.g., content 114, provided by the content provider 104 may be determined based on a preference profile associated with user account 118. The preference profile may indicate brands, topics, products, etc., that a user is interested in seeing more, less, or none of.

According to some examples, rather than the information being provided as an overlay 222 covering a portion of content 114, the information may be provided as a pop-up, as a drop down, as part of the description, or the like. In some examples, the overlay 222 may encompass more of the display of the display device 108 than shown, such that the overlay 222 substantially covers the entirety of the display. Accordingly, while overlay 222 is shown as covering a portion of content 114, it is just one example and is not intended to be limiting as the information may be provided for output in any format, shape, or size.

The visual code 102, whether provided as part of the digital component, as shown in FIG. 1, or in response to receiving a selection of an input, as shown in FIGS. 2A and 2B, may be associated with the content 114. In some examples, the visual code 102 may be associated with account information corresponding to user account 118, parameters associated with the digital component, etc.

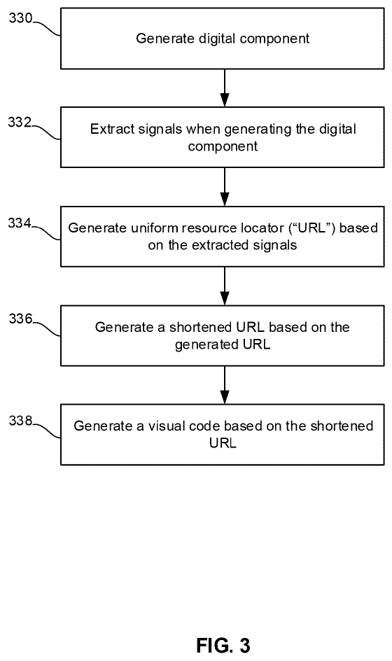

FIG. 3 is an example method for generating a visual code. The following operations do not have to be performed in the precise order described below. Rather, various operations can be handled in a different order or simultaneously, and operations may be omitted.

In block 330, a digital component may be generated. The digital component may be, for example, an advertisement. The digital component may be generated by the content provider 104. In some examples, generating the digital component may include auctioning the digital component space such that digital component providers may bid on the digital component space. The digital component may be generated based on the winning bid at auction.

In block 332, when generating the digital component, one or more signals may be extracted. In some examples, the signals may be extracted from the user account 118 associated with the content provider 104, parameters associated with the digital component, etc.

The account information may include, for example, user demographics, interests, location information, contextual information, etc. The account information may be encrypted data. The account information and, therefore, the extracted signals may be used after receiving authorization from the user. For example, the account information may be used after the user associated with the account provides authorization for the system to access or receive account information. Any use of the account information is authorized by the user. For example, the user may provide authorization to an application for generating visual codes, the online content subscription service, the CTV device, or the like by setting certain permissions for the application. The authorization may be for the application or system to access one or more databases or sub databases in the memory of the device. According to one example, the user may select specific sub-databases to which the application is granted access. For instance, the user may grant access to certain account information, such as the city and state, but not the mailing address.

The parameters associated with the digital component may include, for example, contextual signals, digital component targeting, location information, interest information, etc. Contextual signals may be, for example, signals determined based on the content that was being viewed prior to a digital component being provided for output. Digital component targeting may be, for example, a target audience identified by the digital component provider. The target audience may be a group or type of users the digital component provider seeks to have view the digital component. The location information may be, for example, regional, local, state, etc. information. Interest information may be interest profiles generated based on contextual signals, user provided information, or the like.

In block 334, a URL may be generated based on the extracted signals. The URL generated from the extracted signals may include a large amount of encrypted data. The encrypted data may include, for example, the encrypted account information and/or encrypted signals extracted from the account information. The encrypted data may protect the URL and, therefore, the data associated with the URL, from being readable by an application or system that is not authorized to have access to the data.

In some examples, the encrypted data may only be decrypted after the URL reaches an authorized server. The authorized server may be, for example, a server that has access to the keys used to decrypt the URLs. In some examples, the encryption for the URLs may utilize a rotating key, such that the key to decrypt the URLs changes after a threshold period of time. The threshold period of time may be, for example, hours, days, weeks, months, etc. After the threshold period of time, the URL will no longer be accessible as the associated key will have expired.

If a visual code were to be generated based on the URL generated from the encrypted data, referred to herein as a “large URL,” the resulting visual code would be densely populated. For example, the greater the amount of information to be included in the visual code, the more densely populated the visual code is with modules. A densely populated visual code may be difficult for an image capturing device to accurately capture and discern the visual code, particularly when the capturing device is positioned away from the display, or if that display is resolution, contrast or brightness limited.

To address the potential issues caused by a densely populated visual code, in block 336, a shortened URL may be created based on the large URL.

In block 338, the visual code may be generated based on the shortened URL. By using a shortened URL to generate the visual code, the image capturing device will be able to easily capture and discern the modules of the visual code from both near, e.g., inches away, and far, e.g., television viewing distance away.

Using a visual code to provide access to the information associated with the digital component may allow for the amount of information provided to be increased, without having to change how the information is accessed. For example, the amount of information associated with the digital component may increase as disclosure requirements associated with digital components change, more personalization options are available, or the like. Regardless of the additional information associated with the digital component, the visual code used to access the information associated with the digital component may continue to be generated in the same way, e.g., a URL with the large amount of data is created, a shortened URL is created based on the large URL, and a visual code is created based on the shortened URL such that, when scanned, the shortened URL associated with the visual code leads a user to the content page of the large URL. This may reduce the downtime of an application as no updates would be necessary to increase the amount of information or change the information provided via the visual code. Further, this may reduce distribution requirements for multiple users in that network resources would not need to be used in order to update the data that is provided to users because an app update at the user device is not required.

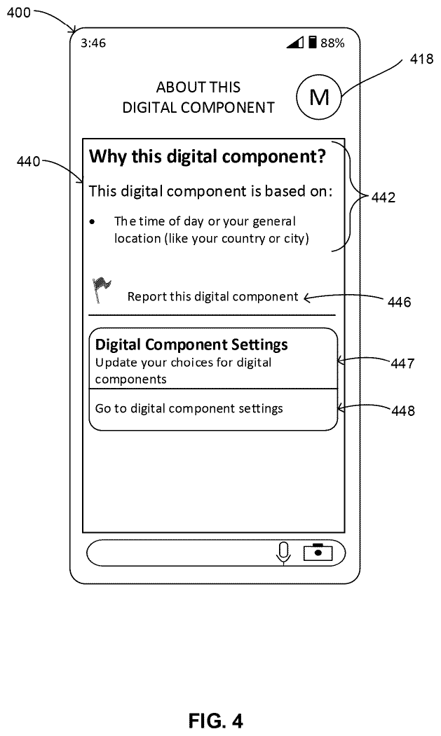

FIG. 4 is an example of content that is provided for display on the user device including the image capturing device in response to scanning the visual code. For example, when the visual code 102 is scanned by an image capturing device of the user device 400, the shortened URL associated with the visual code 102 may be used to redirect the associated content page 440 to the large URL such that the information associated with the large URL and, therefore, the visual code 102, may be provided for display on the user device 400. The information 442 may include, for privacy information, disclosures related to the digital component, digital component personalization information, an explanation regarding why the user is seeing the digital component, or the like. As shown in FIG. 4, the information 442 may relate to why the digital component is being provided for output to the user.

The information 442 associated with the visual code 102 may be provided only after confirming that the account information associated with the user account 118 for the content provider 104 corresponds to the profile information associated with a user profile 418 of the user logged into on the user device 400 used to scan the visual code 102. As one example, the e-mail address associated with the user account 118 for the content provider 104 may be compared to the e-mail address associated with the user profile 418 of the user logged into on the user device 400. If the two e-mail addresses match, the information 442 may be provided for display on the user device 400. In another example, the phone number associated with the user account 118 for the content provider 104 may be compared to the phone number associated with the user profile 418 of the user logged into on the image capture device. If the two phone numbers match, the information 442 may be provided for display on the image capture device. While the examples provided refer to comparing the email addresses and phone number of the user account 118 and the user profile 418, and information associated with the user account 118 and user profile 418 may be compared to determine whether to provide the information 442 for display on the user device 400.

According to some examples, the content page 440 provided for display in response to the user device 400 scanning the visual code 102 may include one or more inputs. The inputs 446-448 may include an input 446 for reporting the digital component, an input 447 to update user choices for the digital component, and an input 448 to be directed to the digital component settings. Updating the digital component settings may, for example, allow the user to provide their preferences regarding the brands, topics, products, etc., that a user is interested in seeing more, less, or none, of. For example, the choice for the digital components may allow for a user to create and/or update their preference profile regarding the brands, topics, products, etc., that a user is interested in seeing more, less, or none, of in digital components.

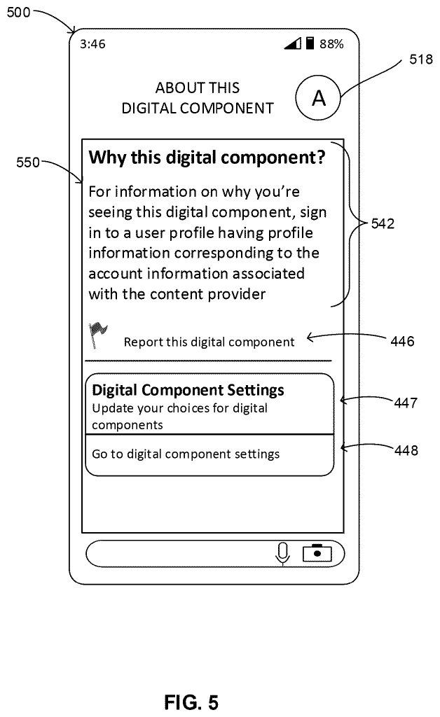

FIG. 5 is another example of content that is provided for display on the user device in response to scanning the visual code. The user device 500 may include the image capturing device for scanning the visual code. For example, after the visual code 102 is scanned by the image capturing device of the user device 500, the account information associated with the user account 118 for the content provider 104 may be compared to the profile information of the user profile 518 of the user logged into on the user device 500. If the account information associated with the user account 118 for the content provider 104 does not correspond to the profile information of the user profile 518 of the user logged into on the user device 500, content page 550 may be provided for output on the display of user device 500.

Compared to content page 440, which provided information associated with the visual code 102 when the account information associated with the user account 118 corresponded to the profile information of the user profile 418, content page 550 provides a prompt 542. The prompt 542 may be for the user to log-in or switch to a user profile having profile information corresponding to the account information. In some examples, an indication of the mismatch of account information and profile information may be provided. The indication may provide an explanation as to why the information associated with the digital component is not provided, e.g., the profile information did not match the account information.

Similar to content page 440, content page 550 may include one or more inputs 446-448, including an input 446 for reporting the digital component, an input 447 to update user choices for digital component, and an input 448 to be directed to the digital component settings.

Comparing the account information, or account data, associated with the user account 118 for the content provider 104 with the profile information, or profile data, associated with a user profile 418, 518 of the user logged into the user device 400, 500 may increase the efficiency of providing access to the information associated with the digital component. For example, the number of transactions between the content provider 104 and the user device 400, 500 may decrease. For example, rather than providing a series of security questions prior to providing the information associated with the digital component, the system may compare the account data associated with the user account 118 for the content provider 104 with the profile data associated with the user profile 418, 518. Additionally or alternatively, the efficiency of determining whether to provide access to the information associated with the visual code may be increased by comparing the account information and profile information as compared to requesting a user to log in each time the visual code is scanned. The increased efficiency of providing access to the information associated with the digital component may reduce the amount of network bandwidth that is used to determine whether the information associated with the digital component may be provided.

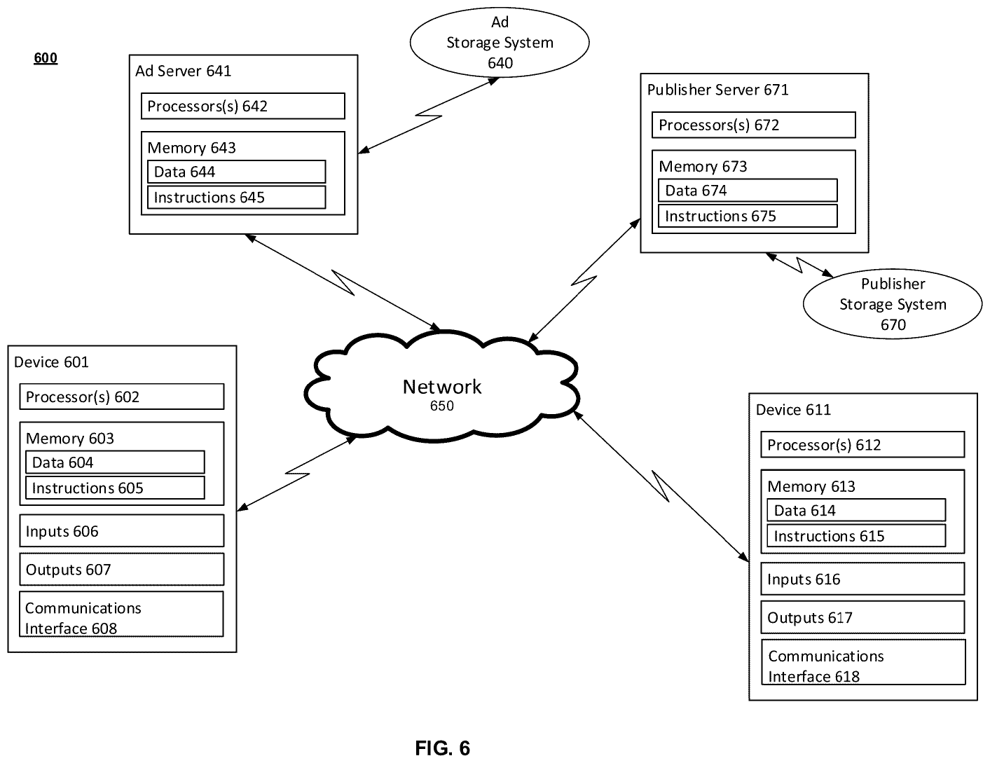

FIG. 6 illustrates an example system in which the features described above and herein may be implemented. It should not be considered as limiting the scope of the disclosure or usefulness of the features described herein. In this example, system 600 includes devices 601, 611, ad server 641, ad server storage system 640, publisher server 671, publisher storage system 670, and network 650. For purposes of clarity, devices 601, 611 will be described with respect to device 601. However, it should be understood that device 611 may include the same or similar components and may function in substantially the same way.

Device 601 may be a user device, such as user device 400, 500 in FIGS. 4 and 5, respectively. Device 601 may include one or more processors 602, memory 603, data 604 and instructions 605. Device 601 may also include inputs 606, outputs 607, and a communications interface 608. The devices 601 may be, for example, a smart phone, tablet, laptop, smart watch, AR/VR headset, smart helmet, home assistant, etc.

Memory 603 of device 601 may store information that is accessible by processor 602. Memory 603 may also include data that can be retrieved, manipulated or stored by the processor 602. The memory 603 may be of any type capable of storing information accessible by the processor 602, including a computer-readable medium, or other medium that stores data that may be read with the aid of an electronic device, such as a hard-drive, memory card, read-only memory (ROM), random access memory (RAM), optical disks, as well as other write-capable and read-only memories. The computer-readable medium may be a non-transitory medium. Memory 603 may store information that is accessible by the processors 602, including instructions 605 that may be executed by processors 602, and data 604.

Data 604 may be retrieved, stored or modified by processors 602 in accordance with instructions 605. For instance, although the present disclosure is not limited by a particular data structure, the data 604 may be stored in computer registers, in a relational database as a table having a plurality of different fields and records, XML documents, or flat files. The data 604 may also be formatted in a computer-readable format such as, but not limited to, binary values, ASCII or Unicode. By further way of example only, the data 604 may comprise information sufficient to identify the relevant information, such as numbers, descriptive text, proprietary codes, pointers, references to data stored in other memories (including other network locations) or information that is used by a function to calculate the relevant data.

The instructions 605 can be any set of instructions to be executed directly, such as machine code, or indirectly, such as scripts, by the processor 602. In that regard, the terms “instructions,” “application,” “steps.” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 602 may include any conventional processors, such as a commercially available CPU or microprocessor. Alternatively, the processor can be a dedicated component such as an ASIC or other hardware-based processor. Although not necessary, device 601 may include specialized hardware components to perform specific computing functions faster or more efficiently.

Although FIG. 6 functionally illustrates the processor, memory, and other elements of device 601 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of device 601. Accordingly, references to a processor or device will be understood to include references to a collection of processors or devices or memories that may or may not operate in parallel.

The inputs 606 may be, for example, a mouse, keyboard, touch-screen, microphone, or any other type of input. The inputs may receive key words for a search on a publisher's website or mobile application. According to some examples, inputs 606 may include a camera or image capturing device. The camera or image capturing device may be a component of or connected to device 601. The image capturing device may be used to capture, scan, etc., visual codes.

Output 607 may be a display, such as a monitor having a screen, a touch-screen, a projector, or a television. The display 607 of the device 601 may electronically display information to a user via a graphical user interface (GUI) or other types of user interfaces. For example, display 607 may electronically display data associated with digital components received in response to scanning a visual code. In some examples, display 607 may electronically display one or more prompts. The prompts may guide a user to login to a user profile having profile data corresponding to account data for a user account associated with a content provider.

The devices 601 can be at various nodes of a network 650 and capable of directly and indirectly communicating with other nodes of network 650. Although two devices are depicted in FIG. 6, it should be appreciated that a typical system can include one or more computing devices, with each computing device being at a different node of network 650. The network 650 and intervening nodes described herein can be interconnected using various protocols and systems, such that the network can be part of the Internet, World Wide Web, specific intranets, wide area networks, or local networks. The network 650 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 600 may include one or more server computing devices, such as ad server 641 and publisher server 671. The server computing devices may be, for example, a load balanced server farm, that exchange information with different nodes of a network for the purpose of receiving, processing and transmitting the data to and from other computing devices. For instance, ad server 641 and publisher server 671 may be a web server that is capable of communicating with the device 601 via the network 650. In addition, ad server 641 and publisher server 671 may use network 650 to transmit and present information to a user of device 601. Ad server 641 and publisher server 671 may include one or more processors 642, 672, memory 643, 673, data 644, 674, instructions 645, 675, etc. These components operate in the same or similar fashion as those described above with respect to device 601.

Ad server 641 may manage content, such as digital components, and provide various services to the advertisers, publishers, and devices 601. According to some examples, ad server 641 may receive ad campaigns from one or more advertisers, such as merchants or creators or virtual goods. The ad campaigns may include campaign information, such as the bidding strategy, targeting information, duration, information related to the digital component, etc. The information related to the digital component may include, for example, privacy information related to the digital component, disclosures related to the digital component, or personalization information for personalizing the digital components. The ad campaigns may be stored in the memory 643 of ad server 641 and/or in ad server storage system 640.

According to some examples, publisher server 671 may provide content for output on a first user device, such as a television display. For example, publisher server 671 may retrieve content from publisher storage system 670 to provide for output to the first user device. The publisher server 671 may transmit a content page or other presentation, representation, or characterization of the content to the requesting device 601. According to some examples, the content page may include, for example, one or more digital components.

In some examples, publisher server 671 may transmit a request for digital components to ad server 641. Ad server 641 may facilitate the identification of relevant digital components for distribution to the publishers. At the time the relevant digital component is identified, the ad server 641 may generate a visual code. The visual code may be associated with the digital component and the account information corresponding to a user account. The visual code may be, in some example, generated based on a URL. The URL may be generated based on signals extracted from the user account, parameters associated with the digital component, or the like. In some examples, the signals include account information associated with the user account, contextual information, location information, preferences, etc. The account information may include, for example, user demographics, interests, location information, contextual information, etc. The user account may be, for example, associated with the content provider that is providing the content and digital component for output on the first user device. The first user device may be, for example, device 601.

The generated URL may include a large amount of data, including encrypted data. To generate a URL that is capable of being accurately captured and discerned, a shortened URL may be generated based on the original, large URL. The shortened URL may then be used to generate the visual code. By using the shortened URL, the modules of the visual code may be less densely populated as compared to a visual code generated with the large URL. A less densely populated visual code may allow for the image capturing device to be able to easily capture and discern the modules from both near, e.g., inches away from the display of the first user device, and far, e.g., television viewing distance away from the display of the first user device. This may also allow the visual code to be displayed on a device that has a limited resolution, contrast or brightness capability.

The ad server 641 may, after generating the visual code associated the visual code with the digital component. For example, the visual code may be included within or near the digital component at the time the digital component is provided for output on the first user device, e.g., device 601. In some examples, a selectable input may be included within or near the digital component at the time the digital component is provided for output. In response to receiving an input corresponding to the selection of the selectable input, the visual code may be provided for display.

Device 601 may present in a viewer, such as a browser, mobile application, or other content display system, the content including one or more of the digital components provided by the ad server 641. The visual code may be within or near the digital component or, in some examples, may be provided in response to receiving an input to display the visual code. A second user device, e.g., device 611, may be used to scan the visual code. For example, device 611 may be an image capturing device or may be a user device including an image capturing device. Upon scanning the visual code provided for display on device 601, the publisher server 671, ad server 641, or another component of the system may compare the account data associated with the user account for the content provided with the profile data associated with a user profile of the user logged into device 611. If the account data corresponds to the profile data, the data associated with the digital component may be provided for output on display of device 611. If the account data does not correspond to the profile data, a prompt may be provided for output on display of device 611. The prompt may be for the user to login to a profile having profile data corresponding to the account data.

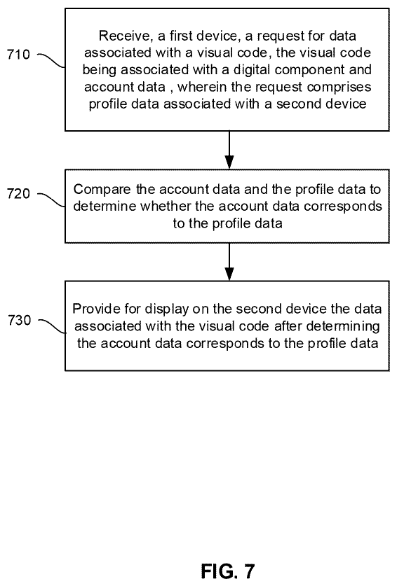

FIG. 7 illustrates an example method for providing data associated with a digital component. The following operations do not have to be performed in the precise order described below. Rather, various operations can be handled in a different order or simultaneously, and operations may be added or omitted.

In block 710, a request for data associated with a visual code may be received from a first device. The visual code may be associated with a digital component and account data. The request may comprise profile data associated with a second device. For example, the first device may be a user device including an image capturing device and the second device may be a display device, such as a television display.

According to some examples, the account data may be associated with a user account. The user account may be associated with a content provider providing the digital component for display on the second device.

The visual code may be, for example, a QR code. In some examples, the visual code may be a bar code or any visual indicator that is capable of being scanned or captured by the image capturing device of the user device.

According to some examples, the visual code and the digital component may be provided for display on the second device. For example, the visual code and the digital component may be provided for display on a television display. The digital component may be, for example, an advertisement. The first device may be an user device including an image capturing device. In some examples, the first device may be an image capturing device configured to scan or capture the visual code.

In block 720, the account data and the profile data may be compared to determine whether the account data corresponds to the profile data. According to some examples, the account data associated with the user profile and the profile data may each include an email address. When comparing the account data and the profile data, the comparing may comprise comparing the email address associated with the account data and the email address associated with the profile data. In some examples, the account data associated with the user profile and the profile data may each include other types of user data, such as phone numbers, locations, etc. When comparing the account data and the profile data, the comparing may comprise comparing any of the types of user data associated with the account data and the profile data.

In block 730, the data associated with the visual code may be provided for display after determining the account data corresponds to the profile data. The data associated with the visual code may be at least one of privacy data, disclosures associated with the digital component, or digital component personalization data. The digital component personalization data may include an option to increase, decrease, or block a subject of the digital component. The subject of the digital component may correspond to a category or classification of at least one of products, goods, or services.

According to some examples, when the account data does not correspond to the profile data, a prompt to log-in or switch to a user profile having profile data corresponding to the account data may be provided for display on the first device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors from a first device, a request for data associated with a visual code, the visual code being associated with a digital component and account data, wherein the request comprises profile data associated with a second device;
comparing, by the one or more processors, the account data and the profile data to determine whether the account data corresponds to the profile data; and
providing for display on the second device, by the one or more processors, the data associated with the visual code after determining the account data corresponds to the profile data.

2. The method of claim 1, further comprising providing for display on the second device, by one or more processors, the visual code and the digital component.

3. The method of claim 2, wherein:
the account data is associated with a user account, and
the user account is associated with a content provider providing the digital component for display on the second device.

4. The method of claim 1, wherein the data associated with the visual code is at least one of privacy data, advertiser disclosures, or digital component personalization data.

5. The method of claim 4, wherein the digital component personalization data includes an option to increase, decrease, or block a subject of the digital component.

6. The method of claim 5, wherein the subject of the digital component corresponds to a category or classification of at least one of products, goods, or services.

7. The method of claim 1, wherein:
the account data and the profile data each include an email address, and
when comparing the account data and the profile data the method further comprises comparing the email address associated with the account data and the email address associated with the profile data.

8. The method of claim 1, wherein when the account data does not correspond to the profile data, the method further comprises providing for display on the first device, by the one or more processors, a prompt to log-in or switch to a user profile having profile data corresponding to the account data.

9. The method of claim 1, wherein the visual code is a QR code.

10. A system, comprising:
one or more processors, the one or more processors configured to:
receive, from a first device, a request for data associated with a visual code, the visual code being associated with a digital component and account data, wherein the request comprises profile data associated with a second device;
compare the account data and the profile data to determine whether the account data corresponds to the profile data; and
provide for display on the second device the data associated with the visual code after determining the account data corresponds to the profile data.

11. The system of claim 10, wherein the one or more processors are further configured to provide for display on the second device the visual code and the digital component.

12. The system of claim 11, wherein:
the account data is associated with a user account, and
the user account is associated with a content provider providing the digital component for display on the second device.

13. The system of claim 10, wherein the data associated with the visual code is at least one of privacy data, advertiser disclosures, or digital component personalization data.

14. The system of claim 13, wherein the digital component personalization data includes an option to increase, decrease, or block a subject of the digital component.

15. The system of claim 14, wherein the subject of the digital component corresponds to a category or classification of at least one of products, goods, or services.

16. The system of claim 10, wherein:
the account data and the profile data each include an email address, and
when comparing the account data and the profile data the method further comprises comparing the email address associated with the account data and the email address associated with the profile data.

17. The system of claim 10, wherein when the account data does not correspond to the profile data, the one or more processors are further configured to provide for display on the first device a prompt to log-in or switch to a user profile having profile data corresponding to the account data.

18. The system of claim 10, wherein the visual code is a QR code.

19. A computer-readable storage medium, the computer-readable storage medium including instructions that when executed by one or more processors, cause the one or more processors to:
receive, from a first device, a request for information associated with a visual code, the visual code being associated with a digital component and account information, wherein the request comprises profile information associated with a second device;
compare the account information and the profile information to determine whether the account information corresponds to the profile information; and
provide for display on the second device the information associated with the visual code after determining the account information corresponds to the profile information.

20. The computer-readable storage medium of claim 19, wherein the one or more processors are further configured to provide for display on the second device the visual code and the digital component.
